(19) United States
(12) Patent Application Publication
(10) Pub. No.: US 2006/0078870 A1
(43) Pub. Date: Apr. 13, 2006

(54) Mannequin for testing and evaluating mannequin garments

(76) Inventors: Winnie Yu, Hong Kong (CN); Jintu Fan, Hong Kong (CN); Yongbao Li, Hong Kong (CN); Hongbo Gu, Hong Kong (CN); Xiaoming Qian, Hong Kong (CN)

Correspondence Address: ALIX YALE & RISTAS LLP, 750 MAIN STREET, SUITE 1400, HARTFORD, CT, 06103, US

(21) Appl. No.: 10/961,660

(22) Filed: Oct. 8, 2004

(51) Int. Cl. G09B 25/00

(52) U.S. Cl. 434/396

(57) ABSTRACT

A mannequin has an artificial skeleton defining a torso area covered with a resilient outer shell shaped to simulate a human torso. The outer shell defines a chest region and a pelvic region. An adaptor located at the chest region, and an artificial breast is detachably connected to the adaptor.

### BACKGROUND OF THE INVENTION

1. Field of the Invention

The invention relates to mannequins and in particular to a mannequin used for testing and evaluating garments.

2. Description of Prior Art

It is important that tight fitting garments are comfortable for the wearer. Males can choose to wear loose fitting undergarments, for example boxer shorts. Females typically have a more limited choice of tight fitting bras, girdles and panties. A lot of research has been done in this area and until now there has been a requirement to use people to test undergarments.

### SUMMARY OF THE INVENTION

It is an object of the present invention to provide a mannequin that allows for realistic testing and evaluation garments, and in particular undergarments.

According to the invention there is provided a mannequin comprising an artificial skeleton defining a torso area, a resilient outer shell covering the skeleton and shaped to simulate a human torso, the outer shell defining a chest region and a pelvic region, an adaptor located at the chest region, and an artificial breast detachably connected to the adaptor.

Preferably, the outer shell is shaped to simulate a female torso and the resilient outer shell simulates resilience of the human torso.

Preferably, the outer shell is covered with a stretch fabric to simulate human skin.

Preferably, the skeleton includes a rib cage defining a chest measurement of the chest region and a pelvis defining a hip measurement of the pelvic region.

Preferably, the rib cage is movable to change the chest measurement and the pelvis is movable to change the hip measurement.

Preferably, the pelvis includes an inflatable bladder into which air can be added or removed to change the hip measurement.

Further aspects of the invention will become apparent from the following drawings and description.

### BRIEF DESCRIPTION OF THE DRAWINGS

Embodiments of the invention will now be described by way of example only and with reference to the accompanying drawings in which:

FIG. 1 illustrates a first sectional view through a mannequin according to the invention,

FIG. 2 is a second sectional view through the mannequin,

FIG. 3 is a side sectional view through the mannequin,

FIG. 4 is a partial exploded view of an adaptor for securing an artificial breast to the mannequin,

FIG. 5 is an assembled view of the adaptor, and

FIG. 6 illustrates the artificial breast.

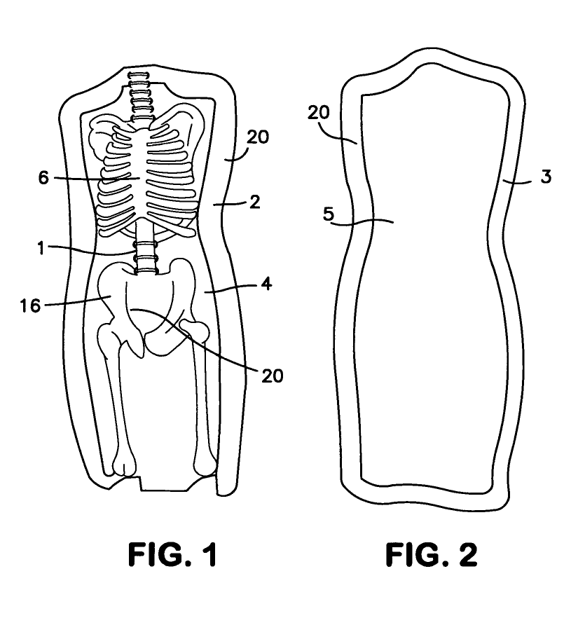

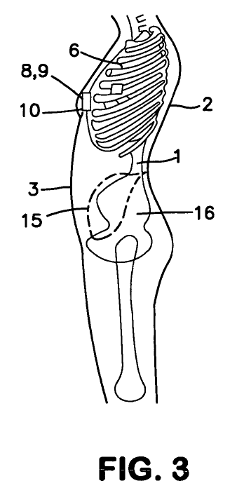

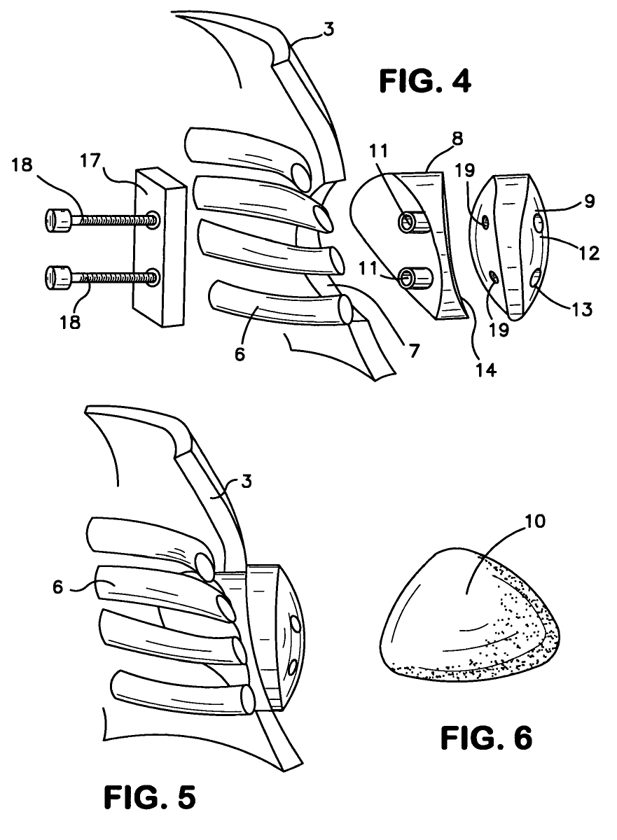

### DESCRIPTION OF THE PREFERRED EMBODIMENTS

In the drawings there is depicted a mannequin for evaluating and testing undergarments. The mannequin comprises an artificial skeleton 1 covered with a resilient outer shell that simulates the shape of a human torso. In the preferred embodiment the outer shell simulates the female torso.

The skeleton 1 is made from tough plastic material and is in the shape of a full size human torso comprising a spine, rib cage, pelvis and thigh bones.

The outer shell is made of a resilient flexible material moulded in two halves 2, 3. The two halves 2, 3 comprise a rear half 2 having a recess 4 into which the skeleton 1 locates. The front half 3 has a recess 5 in the shape of the skeleton and joins the first half at a flange 20 for securing together the outer shell. The shell halves are made by filing moulds with liquid polyurethane foam. The outer shell is made from polyurethane foam of a density suitable to simulate the resilience of the human torso.

An outer layer of stretch fabric covers the outer shell to simulate human skin. After the foam matures completely the outer skin fabric is applied to the outer shell. In an alternative embodiment the stretch fabric is replaced by one thin layer of smooth, elastic polyurethane, which results from the spray of liquid polyurethane on the insides of mould before moulding the mannequin.

The chest area of the front shell half 3 has an opening 7 exposing several of the skeleton ribs 6. A mounting bracket 8 locates within the opening 7 and has locating posts 11 which project between the ribs 6. A securing bracket 17 is located behind the ribs 6 and has bolts 18 that pass through posts 11. An adaptor 9 is located to front face 14 of mounting bracket 8. The bolts 18 engage within threaded sockets 19 of the adaptor 9 to secure the bracket 8 and adaptor 9 to the mannequin. On the front face of adaptor 9 are locating points 12 and 13 for securing an artificial breast 10 to the adaptor 9. The artificial breast 10 is a silicon or liquid filled bag similar to the type used as a breast prosthesis.

The rib cage 6 of skeleton 1 can be made moveable in order to enlarge the chest dimension of the mannequin. The breasts 10 are interchangeable so that the mannequin can have different size breasts. These features enable the mannequin to be adjusted for use with different chest and cup size bras (not shown) for testing and evaluation. The width and height of the skeleton can also be altered to match the mannequin size.

An inflatable bladder 15 can be located within cavity 20 of pelvis bone 16. By inflating or deflating the bladder 15 the hip and tummy dimensions of the mannequin can be altered for testing different size panties.

The outer shell material has a resilience that simulates the deformation properties of the human torso. Ultrasound testing is used to measure the properties of human tissue and match it with the resilient material.

The artificial breast 10 simulates the resilience and feel of a real breast. Bra and panty undergarments are fitted to the mannequin after adjustment to the appropriate garment size. Commercially available thin-flim pressure sensors are located at suitable points between the undergarment and mannequin. The pressure sensors are connected to monitoring equipment so that the pressure applied to the mannequin by the undergarment can be recorded. This data is used to evaluate the comfort and wearability of the undergarment on a human body.

Typical undergarments that can be tested include panties, girdles, bras and medical pressure garments. The mannequin can be used for psychological and comfort studies of a human body.

In an alternative embodiment the pressure sensors can be included in the outer shell during the manufacturing process. Additionally, different sections of the outer shell can be made with different polyurethane densities to simulate harder and softer areas of the human torso.

Where in the foregoing description reference has been made to integers or elements having known equivalents then such are included as if individually set forth herein.

Embodiments of the invention have been described, however it is understood that variations, improvement or modifications can take place without departure from the spirit of the invention or scope of the appended claims.

What is claimed is:

1. A mannequin comprising:
an artificial skeleton defining a torso area, a resilient outer shell covering the skeleton and shaped to simulate a human torso, the outer shell defining a chest region and a pelvic region,
an adaptor located at the chest region, and
an artificial breast detachably connected to the adaptor.

2. The mannequin of claim 1 wherein the outer shell is shaped to simulate a female torso.

3. The mannequin of claim 1 wherein the resilient outer shell simulates resilience of the human torso.

4. The mannequin of claim 1 wherein the outer shell is covered with a stretch fabric to simulate human skin.

5. The mannequin of claim 1 wherein the skeleton includes a rib cage defining a chest measurement of the chest region and a pelvis defining a hip measurement of the pelvic region.

6. The mannequin of claim 5 wherein the rib cage is movable to change the chest measurement.

7. The mannequin of claim 5 wherein the pelvis is movable to change the hip measurement.

8. The mannequin of claim 5 wherein the pelvis includes an inflatable bladder into which air can be added or removed to change the hip measurement.
